(19) United States
(12) Patent Application Publication
(10) Pub. No.: US 2009/0129907 A1
(43) Pub. Date: May 21, 2009

(54) Weight Ballast for a Counterweight Device and Method of Making thereof

(76) Inventor: Chun-Ming Huang, Taiping City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/188,387

(22) Filed: Aug. 8, 2008

(30) Foreign Application Priority Data
Nov. 15, 2007 (TW) 96143314

(51) Int. Cl. B66F 19/00; B66B 17/12

(52) U.S. Cl. 414/673; 264/337

(57) ABSTRACT

A weight ballast having a reduced cost of manufacture includes a housing filled with a filling. The housing includes a bottom side, two lateral sides, with the two lateral sides, two terminal sides and bottom side defining a compartment as well as an opening to allow the filling being poured into the housing. The housing further including two lugs extending longitudinally with respect to a longitudinal axis of the housing from the two terminal sides respectively, and with each of the two lugs including a cavity connected to and in communication with the compartment. The filling is a mixture of cement and scum with a predetermined specific weight.

### BACKGROUND OF THE INVENTION

1. Field of the Invention

The present invention relates to a weight ballast utilized in a counterweight device and method of manufacturing thereof, in particular, to a weight ballast which has a reduced cost of manufacture.

2. Description of the Related Art

Generally, a material for making a weight ballast for a counterweight is cast iron but the cost of the metallic material is not cheap. Furthermore, the weight ballast is generally produced by casting, so a precisely made mold is required, otherwise when the weight ballast is removed from the mold, further finishing which incurs more cost of manufacture would be required.

Referring to FIGS. 1 and 2, a known weight ballast 1 includes two flanges is 2 extended longitudinally with respect to a longitudinal axis of the weight ballast, and one of the flange 2 is extended from a proximal end whereas the other flange 2 is extended from a distal end, respectively. Because the flange 2 are suspended in the air, the weight ballast 1 is susceptible to breakage due to a substantial shear stress at a corner 3 defined between a bottom side of the flange 2 and a side of the respective end of the weight ballast 1.

Other related arts including U.S. Pat. No. 7,387,192 to Cloux, which discloses a ballast weight made of two interlocked parts and for facilitating installation of the ballast weight to a counterweight device as well as U.S. Pat. No. 7,219,771 to Augugliaro and U.S. Pat. No. 5,208,201 to Yoo. However, none of these references disclose a weight ballast which has an advantage of reduced cost of manufacture and the method of making thereof.

The present invention is, therefore, intended to obviate or at least alleviate the problems encountered in the prior art.

### SUMMARY OF THE INVENTION

According to the present invention there is provided, a weight ballast having a reduced cost of manufacture includes a housing filled with a filling. The housing is made of metal including a bottom side, two lateral sides, with the two lateral sides, two terminal sides and bottom side defining a compartment as well as an opening to allow the filling being poured into the housing. The housing further including two lugs extending longitudinally with respect to a longitudinal axis of the housing from the two terminal sides respectively, and with each of the two lugs including a cavity connected to and in communication with the compartment. The filling is a mixture of cement and scum with a predetermined specific weight.

According to the present invention, a method for making the weight ballast includes preparing a filling; using a mixer to mix the filling; providing the housing; and pouring the filling into the housing.

In one aspect of the present invention, the housing and the filling are utilized to make the weight ballast.

In another aspect of the present invention, the recycled use of scum in this embodiment not only has favors as to the environment but also a reduced cost of the weight ballast.

In yet the other aspect of the present invention, the specific weight of the filling is predetermined.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The present invention will be described with reference to the accompanying drawings which assist in illustrating the pertinent features thereof, in which:

FIG. 1 is a perspective view of a conventional weight ballast for a counterweight device.

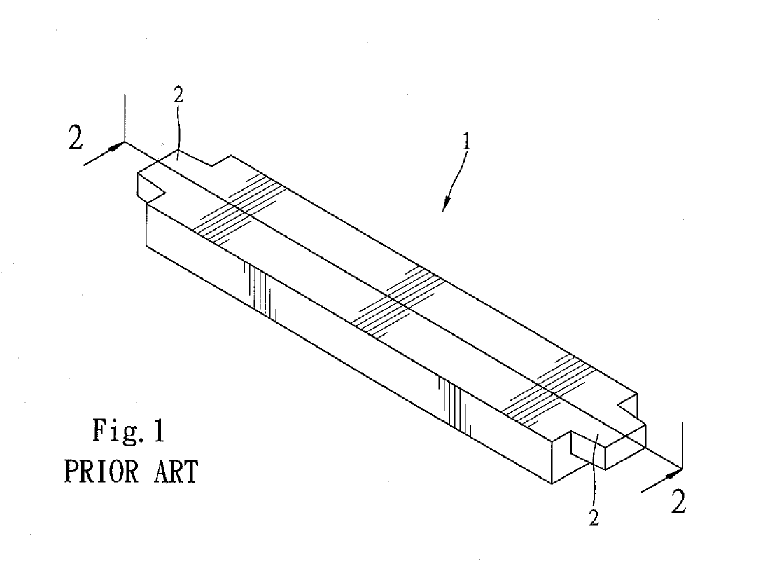

FIG. 2 is a cross-sectional view taken along line 2-2 in FIG. 1.

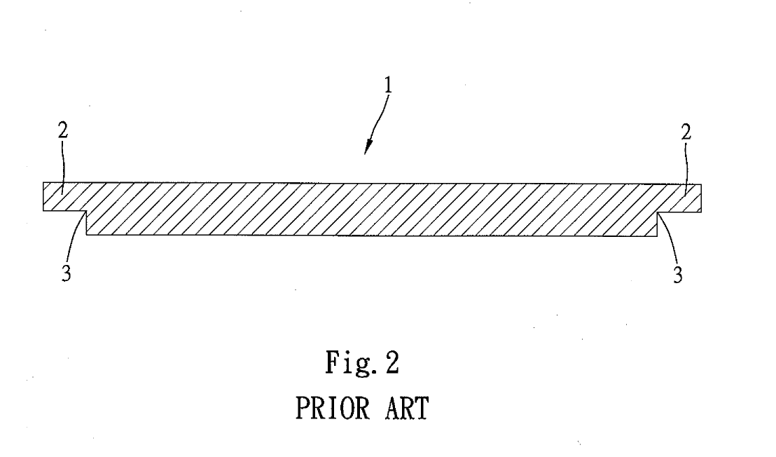

FIG. 3 is a flow chart showing the process of making a weight ballast for a counterweight device in accordance with the present invention.

FIG. 4 is a perspective view of a weight ballast for a counterweight device in accordance with the present invention.

FIG. 5 is a cross-sectional view taken along line 5-5 in FIG. 4.

FIG. 6 is a cross-sectional view taken along line 6-6 in FIG. 4.

FIG. 7 is a perspective view of a housing of the weight ballast in accordance with the present invention.

FIG. 8 is a cross-sectional view taken along line 8-8 in FIG. 7.

### DETAILED DESCRIPTION OF THE PREFERRED EMBODIMENT

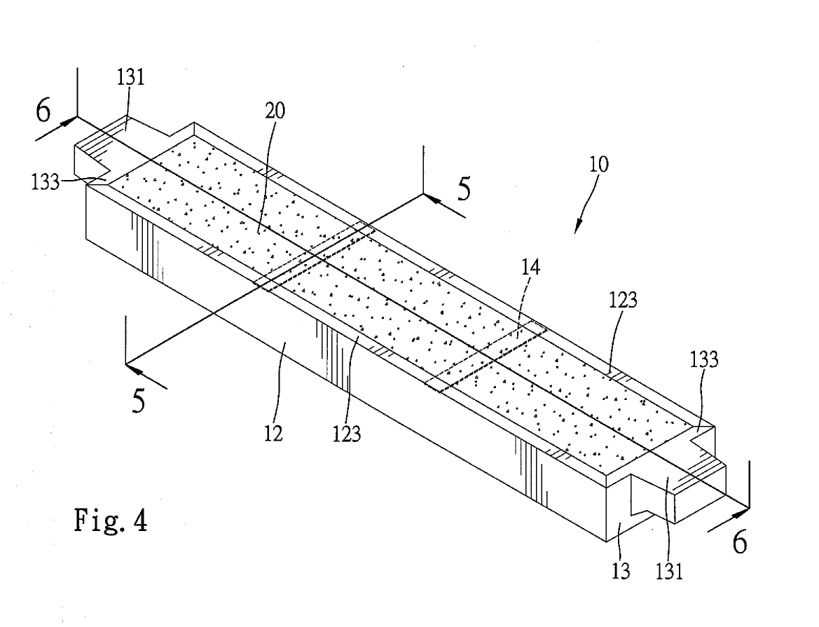

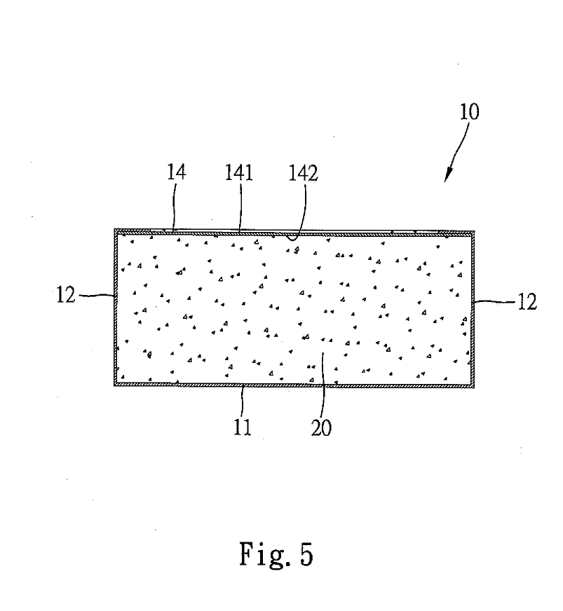

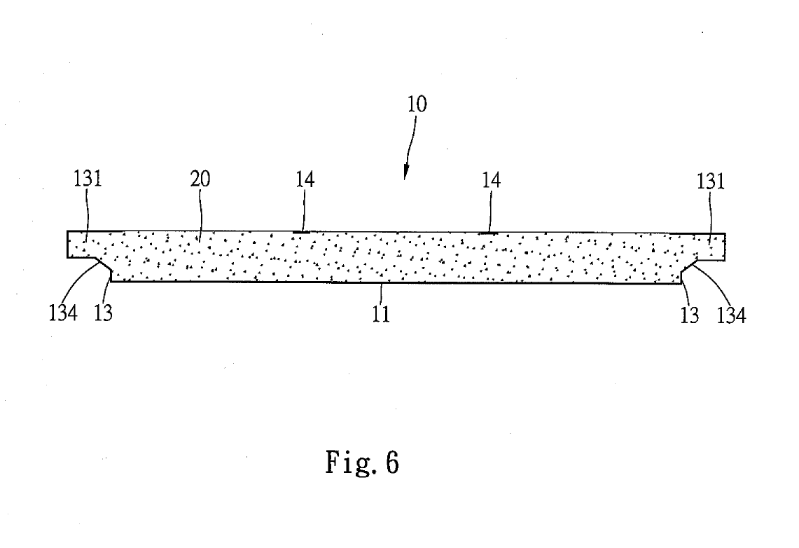

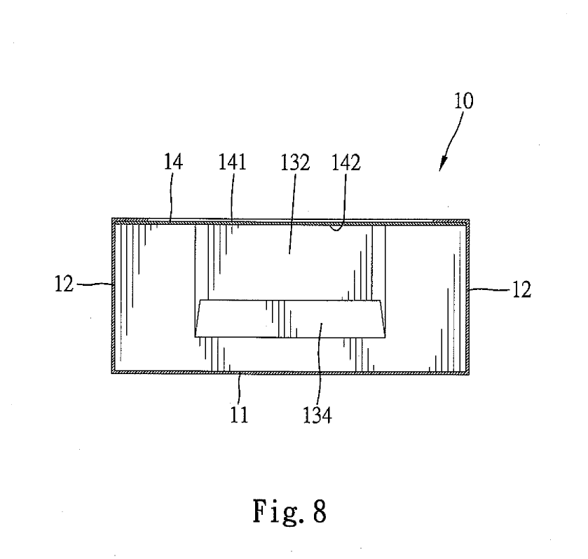

Referring to FIGS. 4 through 8, a weight ballast for a counterweight device in accordance with the present invention includes a housing 10 filled with a filling 20. The housing 10 is made of metal and would be made corrosion proof. The filling 20 is a mixture of cement and scum with a predetermined specific weight. The recycled use of scum in this embodiment not only has favors as to the environment but also a reduced cost of the weight ballast.

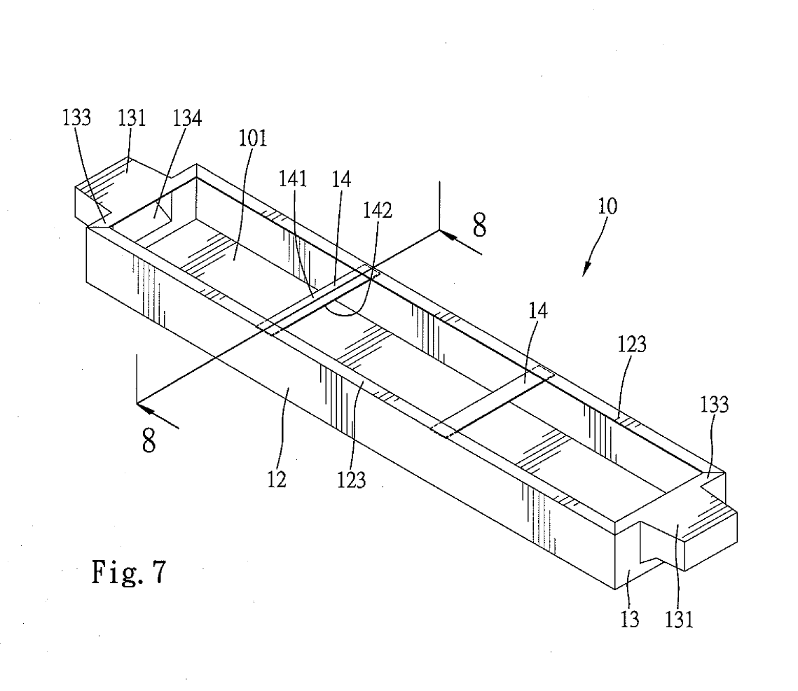

As best shown in FIG. 7, the housing 10 includes a bottom side 11, two lateral sides 12 opposed to one another and extending upward from two edges of the bottom side 11 respectively, and two terminal side 13 opposed to one another and extending upward from the other two edges of the bottom side 11 respectively, all to define a compartment 101 as well as an opening to allow the filling 20 being poured into the housing 10. Moreover, two lugs 131 extend longitudinally with respect to a longitudinal axis of the housing 10 from the two terminal sides 13, respectively, and each of the two lugs 13 encloses a cavity 132 which is connected to and in communication with the compartment 101. In this case, the filling 20 is adapted to be disposed in the compartment 101 as well as the two cavities 132.

To reinforce the structure of the housing 10 while prevent the filling 20 from overbriming the opening of the compartment 101, each of the two lateral sides 12 includes a first ledge 123 extending from an edge opposite to the edge connected the bottom side 11, and each of the two terminal sides 13 includes a second ledge 133 extending partially from an edge opposite to the edge connected the bottom side 11 and partially from a first edge of the associated lug 131 so that the opening of the compartment 11 is adapted to be delimited by the two ledges 123 of the two associated lateral sides 12 and two ledges 133 of the two associated terminal sides 13. Preferably, the first edge of the associated lug 131 extends substantially transversely from the respective terminal side 13. In addition, each lug 131 includes a second edge substantially parallel to the first edge and extending from a connecting edge 134 extended from the respective terminal side 13. Preferably, the connecting edge 134 is angled with respect to the second edge and terminal side 13 for reducing shear stress concentration.

At least two reinforcing members 14 are also utilized to reinforce the structure of the housing 10. Each of the at least two reinforcing members 14 is made of metal and has an upper side 141 and an underside 142 being planar and parallel to the bottom side 11 of the housing 10 as well as a first end and a second end connected to the ledges 123 of the two lateral sides 12, respectively. The at least two reinforcing members 14 extend between the two lateral sides 12 and both are positioned intermediately between the two terminal sides 13 in a manner that one of the terminal sides 13 is spaced from one of the at least two reinforcing members 14 at a first distance, and one of the at least two reinforcing members 14 is spaced from the other of the at least two reinforcing members 14 at a second distance, and the other of the at least two reinforcing members 14 is spaced from the other of the two terminal sides 13 at a third distance, and with the first, second and third distances being equal. It is understood that if there are three reinforcing member 14 utilized, one of terminal sides 13 would be spaced from a first of the three reinforcing members 14 at a distance equal to a distance between the first reinforcing members 14 and a second of the three reinforcing members 14; and equal to a distance between the second reinforcing member 14 and a third of three reinforcing members 14; and equal to a distance between the third reinforcing members 14 and the other of the two terminal sides 13.

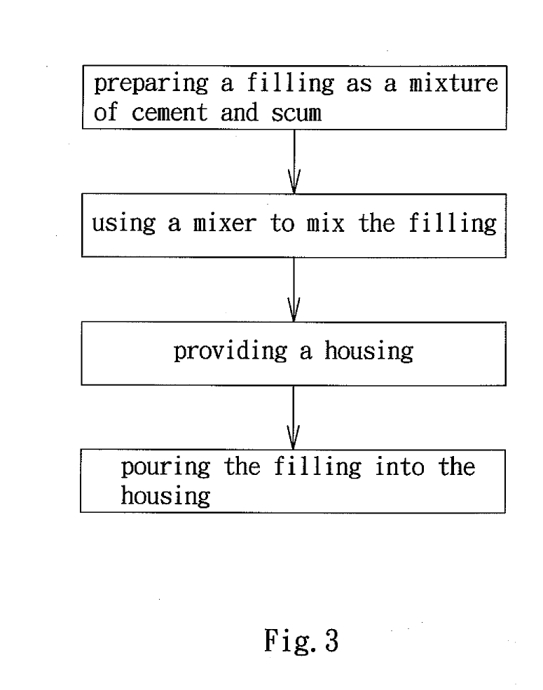

Referring to FIG. 3 for a method for making the weight ballast, the method includes preparing the filling 20; using a mixer to mix the filling 20; providing the housing 10; and pouring the filling 20 into the housing 10.

Preferably, the bottom side 11, two lateral sides 12, two terminal side 13 and two lugs 131 are integrally formed. Or otherwise, these parts may form independently and connect to one another by welding process or other suitable means.

While the specific embodiments have been illustrated and described, numerous modifications come to mind without significantly departing from the spirit of invention and the scope of invention is only limited by the scope of accompanying claims.

What is claimed is:

1. A weight ballast for a counterweight device comprising:
a housing made of metal including a bottom side, two lateral sides opposed to one another and extending upward from two edges of the bottom side respectively, and two terminal side opposed to one another and extending upward from the other two edges of the bottom side respectively, with the two lateral sides, two terminal sides and bottom side defining a compartment having an opening, with each of the two lateral sides including a first ledge extending from an edge opposite to the edge connected the bottom side, with each of the two terminal sides including a second ledge extending from an edge opposite to the edge connected the bottom side; and
a filling prepared as a mixture of cement and scum filled in the compartment; and
wherein the first and second ledges reinforce structure of the housing while prevent the filled filling from overbriming the opening of the compartment.

2. The weight ballast for a counterweight device as claimed in claim 1, with housing including two lugs extending longitudinally with respect to a longitudinal axis of the housing from the two terminal sides respectively, and with each of the two lugs including a cavity connected to and in communication with the compartment.

3. The weight ballast for a counterweight device as claimed in claim 2, with each of the cavities being enclosed by the associated lug, and with each of the two lugs including a first edge extending substantially transversely from one of the terminal sides and a second edge substantially parallel to the first edge and extending from a connecting edge, with the connecting edge extending from said one of the terminal sides, and with the connecting edge angled with respect to the second edge and said terminal side.

4. The weight ballast for a counterweight device as claimed in claim 1, with the housing including at least two reinforcing members made of metal and extending between the two lateral sides, with the at least two reinforcing members positioned intermediately between the two terminal sides, with one of the terminal sides spaced from one of the at least two reinforcing members at a first distance, with one of the at least two reinforcing members spaced from the other of the at least two reinforcing members at a second distance, with the other of the at least two reinforcing members spaced from the other of the terminal side at a third distance, and with the first, second and third distances being equal.

5. The weight ballast for a counterweight device as claimed in claim 4, with each of the at least two reinforcing members having an underside being planar and parallel to the bottom side of the housing, a first end and a second end connected to the ledges of the two lateral sides, respectively.

6. The weight ballast for a counterweight device as claimed in claim 1, with the opening of the compartment delimited by the two ledges of the two associated lateral sides and two ledges of the two associated terminal sides.

7. The weight ballast for a counterweight device as claimed in claim 2, with the housing including at least two reinforcing members made of metal and extending between the two lateral sides, with the at least two reinforcing members positioned intermediately between the two terminal sides, with one of the terminal sides spaced from one of the at least two reinforcing members at a first distance, with one of the at least two reinforcing members spaced from the other of the at least two reinforcing members at a second distance, with the other of the at least two reinforcing members spaced from the other of the terminal side at a third distance, and with the first, second and third distances being equal.

8. The weight ballast for a counterweight device as claimed in claim 7, with each of the at least two reinforcing members having an underside being planar and parallel to the bottom side of the housing, a first end and a second end connected to the ledges of the two lateral sides, respectively.

9. A method for making a weight ballast for a counterweight device comprising:
preparing a filling as a mixture of cement and scum having a predetermined specific weight;
using a mixer to mix the filling; and
providing a housing; and
pouring the filling into the housing.

10. The method as claimed in claim 9 wherein the housing is made from metal and is corrosion proof

11. The method as claimed in claim 9, wherein the housing includes a bottom side, two lateral sides opposed to one another and extending upward from two edges of the bottom side respectively, and two terminal side opposed to one another and extending upward from the other two edges of the bottom side respectively, with the two lateral sides, two terminal sides and bottom side defining a compartment having an opening, with each of the two lateral sides including a first ledge extending from an edge opposite to the edge connected the bottom side, with each of the two terminal sides including a second ledge extending from an edge opposite to the edge connected the bottom side.

12. The method as claimed in claim 1, wherein the housing includes two lugs extending longitudinally with respect to a longitudinal axis of the housing from the two terminal sides respectively, and with each of the two lugs including a cavity connected to and in communication with the compartment.

13. The method as claimed in claim 11, wherein the housing includes at least two reinforcing members made of metal and extending between the two lateral sides, with the at least two reinforcing members positioned intermediately between the two terminal sides, with one of the terminal sides spaced from one of the at least two reinforcing members at a first distance, with one of the at least two reinforcing members spaced from the other of the at least two reinforcing members at a second distance, with the other of the at least two reinforcing members spaced from the other of the terminal side at a third distance, and with the first, second and third distances being equal.

14. The method as claimed in claim 13, wherein each of the at least two reinforcing members has an underside being planar and parallel to the bottom side of the housing, a first end and a second end connected to the ledges of the two lateral sides, respectively.

15. The method as claimed in claim 11, wherein the opening of the compartment is delimited by the two ledges of the two associated lateral sides and two ledges of the two associated terminal sides.

16. The method as claimed in claim 11, wherein each of the cavities is enclosed by the associated lug, and with each of the two lugs including a first edge extending substantially transversely from one of the terminal sides and a second edge substantially parallel to the first edge and extending from a connecting edge, with the connecting edge extending from said one of the terminal sides, and with the connecting edge angled with respect to the second edge and said terminal side.
